(19) United States
(12) Patent Application Publication
(10) Pub. No.: US 2014/0028839 A1
(43) Pub. Date: Jan. 30, 2014

(54) IMAGE PROCESSING METHOD, STORAGE MEDIUM, IMAGE PROCESSING APPARATUS AND IMAGE PICKUP APPARATUS

(71) Applicant: CANON KABUSHIKI KAISHA, Tokyo (JP)

(72) Inventor: Tomohiko ISHIBASHI, Utsunomiya-shi (JP)

(73) Assignee: CANON KABUSHIKI KAISHA, Tokyo (JP)

(21) Appl. No.: 13/949,418

(22) Filed: Jul. 24, 2013

(30) Foreign Application Priority Data
Jul. 27, 2012 (JP) 2012-167763

(51) Int. Cl. H04N 9/64

(52) U.S. Cl. CPC H04N 9/646
USPC 348/140; 348/242

(57) ABSTRACT

The image processing method includes acquiring an input image produced by image capturing through an image capturing optical system tilted with respect to an image pickup plane, acquiring tilt information showing a condition of the tilt of the image capturing optical system in the image capturing, and performing an image process on the input image, by using information on aberration of the image capturing optical system corresponding to the tilt information, to correct image degradation caused by the aberration. The tilt information shows a tilt direction and a tilt angle of the image capturing optical system with respect to the image pickup plane. The method acquires object distances for respective image heights in the image pickup plane by using the tilt direction and the tilt angle and performs the image process corresponding to the object distance for each image height.

### BACKGROUND OF THE INVENTION

1. Field of the Invention

The present invention relates to an image processing technique for correcting degradation in images produced by image capturing, particularly to an image processing technique for correcting degradation generated by tilt photography or shift photography.

2. Description of the Related Art

Using an image capturing optical system provided with a tilt mechanism or a shift mechanism with an image pickup apparatus such as a digital still camera or a digital video camera enables tilt photography or shift photography (correctively referred to “tilt-shift photography”) Such tilt-shift photography makes it possible to control an object plane on which the image capturing optical system is focused and to correct distortion due to perspective.

The tilt photography is performed by tilting the image capturing optical system with respect to an image pickup plane, which enables focusing of the image capturing optical system on the whole of a deep object plane without increasing depth of field and enables narrowing of a distance range on which the image capturing optical system is focused. On the other hand, the shift photography is performed by moving (shifting) the image capturing optical system parallel to the image pickup plane, which enables correction of the distortion caused by the perspective generated when the object plane is not parallel to the image pickup plane.

Moreover, captured images produced by the above-mentioned digital image pickup apparatus are subjected to various digital image processes. For example, performing an image restoration process, a correction process for chromatic aberration of magnification and a distortion correction process on a captured image degraded due to aberration of the image capturing optical system makes it possible to provide a high quality image in which influences of the aberration is reduced.

However, the image capturing optical system having the tilt or shift mechanism does not always provide a rotationally symmetric imaging performance about a center of the image pickup plane (image center), which is different from general optical system symmetric about its optical axis. That is, the image capturing optical system having the tilt or shift mechanism generates a non-rotationally symmetric eccentric aberration in an image height direction, which degrades its optical performance as compared with a reference condition where the image capturing optical system is not tilted or shifted.

Therefore, when performing the image processes on the captured image obtained by tilt-shift photography, it is necessary to change a condition or a method of each image process depending on a tilt-shift photography condition.

Japanese Patent Laid-Open Nos. 2008-42348 and 2003-244526 disclose image processing methods for a captured image obtained by tilt-shift photography. Japanese Patent Laid-Open No. 2008-42348 discloses a method for preventing, when a foreign particle correction image process is performed on a captured image to correct unnecessary images of foreign particles attached to an image capturing optical system, the foreign particle correction image process from being inadequately performed in response to change of captured positions of the unnecessary images which is caused by tilt or shift of the image capturing optical system. On the other hand, Japanese Patent Laid-Open No. 2003-244526 discloses a method for correcting non-rotationally symmetric shading in a captured image obtained by tilt-shift photography. Moreover, Japanese Patent Laid-Open No. 2010-258570 discloses a method for correcting, by an image restoration process using an image restoration filter, eccentric aberration caused by shift of an image stabilizing lens in a direction orthogonal to an optical axis to correct image blur due to shaking of an image pickup apparatus.

However, the methods disclosed in Japanese Patent Laid-Open Nos. 2008-42348 and 2003-244526 only enable correction of the captured image including the foreign particle images or the shading, but do not enable correction of image degradation due to the eccentric aberration unique to the tilt-shift photography.

Moreover, the method disclosed in Japanese Patent Laid-Open No. 2010-258570 only enables correction of the eccentric aberration caused by the shift of the image stabilizing lens, but does not enable correction of eccentric aberration caused by the tilt photography in which object distances are different for respective image heights on a basis of Scheimpflug principle. Furthermore, the image capturing optical system having the tilt or shift mechanism is designed to have a high design image height in consideration of a maximum tilt or shift amount, and a specific part of the design image height is used in the tilt or shift photography. The method disclosed in Japanese Patent Laid-Open No. 2010-258570 does not consider determination of an image height used in image capturing and amounts of eccentric aberration corresponding to the image heights, so that it cannot correct the eccentric aberration caused by the tilt-shift photography well.

### BRIEF SUMMARY OF THE INVENTION

The present invention provides an image processing method, storage medium stored in an image processing program, an image processing apparatus and image pickup apparatus each capable of correcting the image degradation due to the tilt-shift photography well.

The present invention provides as one aspect thereof an image processing method including acquiring an input image produced by image capturing through an image capturing optical system tilted with respect to an image pickup plane, acquiring tilt information showing a condition of the tilt of the image capturing optical system in the image capturing, and performing an image process on the input image, by using information on aberration of the image capturing optical system corresponding to the tilt information, to correct image degradation caused by the aberration. The tilt information shows a tilt direction and a tilt angle of the image capturing optical system with respect to the image pickup plane. The method acquires object distances for respective image heights in the image pickup plane by using the tilt direction and the tilt angle and performs the image process corresponding to the object distance for each image height.

The present invention provides as another aspect thereof an image processing apparatus including an image acquirer configured to acquire an input image produced by image capturing through an image capturing optical system tilted with respect to an image pickup plane, a tilt information acquirer configured to acquire tilt information showing a condition of the tilt of the image capturing optical system in the image capturing, and a processor configured to perform an image process on the input image, by using information on aberration of the image capturing optical system corresponding to the tilt information, to correct image degradation caused by the aberration. The tilt information shows a tilt direction and a tilt angle of the image capturing optical system with respect to the image pickup plane. The processor is configured to acquire object distances for respective image heights in the image pickup plane by using the tilt direction and the tilt angle and to perform the image process corresponding to the object distance for each image height.

The present invention provides as still another aspect thereof an image pickup apparatus including an image capturer configured to perform image capturing through an image capturing optical system tilted with respect to an image pickup plane to produce a captured image, and the above image processing apparatus.

The present invention provides as yet another aspect thereof a non-transitory computer-readable storage medium storing an image processing program that causes a computer to perform an operation including acquiring an input image produced by image capturing through an image capturing optical system tilted with respect to an image pickup plane, acquiring tilt information showing a condition of the tilt of the image capturing optical system in the image capturing, and performing an image process on the input image, by using information on aberration of the image capturing optical system corresponding to the tilt information, to correct image degradation caused by the aberration. The tilt information shows a tilt direction and a tilt angle of the image capturing optical system with respect to the image pickup plane. The method acquires object distances for respective image heights in the image pickup plane by using the tilt direction and the tilt angle and performs the image process corresponding to the object distance for each image height.

The present invention provides as yet still another aspect thereof an image processing method including acquiring an input image produced by image capturing through an image capturing optical system shifted with respect to an image pickup plane, acquiring shift information showing a condition of the shift of the image capturing optical system in the image capturing, and performing an image process on the input image, by using information on aberration of the image capturing optical system corresponding to the shift information, to correct image degradation caused by the aberration.

The present invention provides further another aspect thereof an image processing apparatus including an image acquirer configured to acquire an input image produced by image capturing through an image capturing optical system shifted with respect to an image pickup plane, a shift information acquirer configured to acquire shift information showing a condition of the shift of the image capturing optical system in the image capturing, and a processor configured to perform an image process on the input image, by using information on aberration of the image capturing optical system corresponding to the shift information, to correct image degradation caused by the aberration.

The present invention provides as further another aspect thereof an image pickup apparatus including an image capturer configured to perform image capturing through an image capturing optical system tilted with respect to an image pickup plane to produce a captured image, and the above image processing apparatus.

The present invention provides further another aspect thereof a non-transitory computer-readable storage medium storing an image processing program that causes a computer to perform an operation including acquiring an input image produced by image capturing through an image capturing optical system shifted with respect to an image pickup plane, acquiring shift information showing a condition of the shift of the image capturing optical system in the image capturing, and performing an image process on the input image, by using information on aberration of the image capturing optical system corresponding to the shift information, to correct image degradation caused by the aberration.

Other aspects of the present invention will become apparent from the following description and the attached drawings.

### BRIEF DESCRIPTION OF THE DRAWINGS

FIG. 1 shows tilt photography according to Scheimpflug principle in each embodiment of the present invention.

FIG. 2 shows shift photography in each embodiment.

FIG. 3 shows an image restoration filter used in an image processing method in each embodiment.

FIG. 4 is a sectional view of the image restoration filter.

FIGS. 5A and 5B show correction of a point image by the image processing method of each embodiment.

FIGS. 6A and 6B show correction of amplitude and phase by the image processing method in each embodiment.

FIG. 7 is a flowchart showing the image process method that is Embodiment 1 of the present invention.

FIGS. 8A to 8D show an optical transfer function relating to an image restoration process performed in Embodiment 1.

FIG. 9 shows a configuration of an image processing system including an image processing apparatus that is Embodiment 2 of the present invention.

FIG. 10 shows a configuration of an image pickup apparatus that is Embodiment 3 of the present invention.

### DETAILED DESCRIPTION OF THE EMBODIMENTS

Exemplary embodiments of the present invention will hereinafter be described with reference to the accompanying drawings.

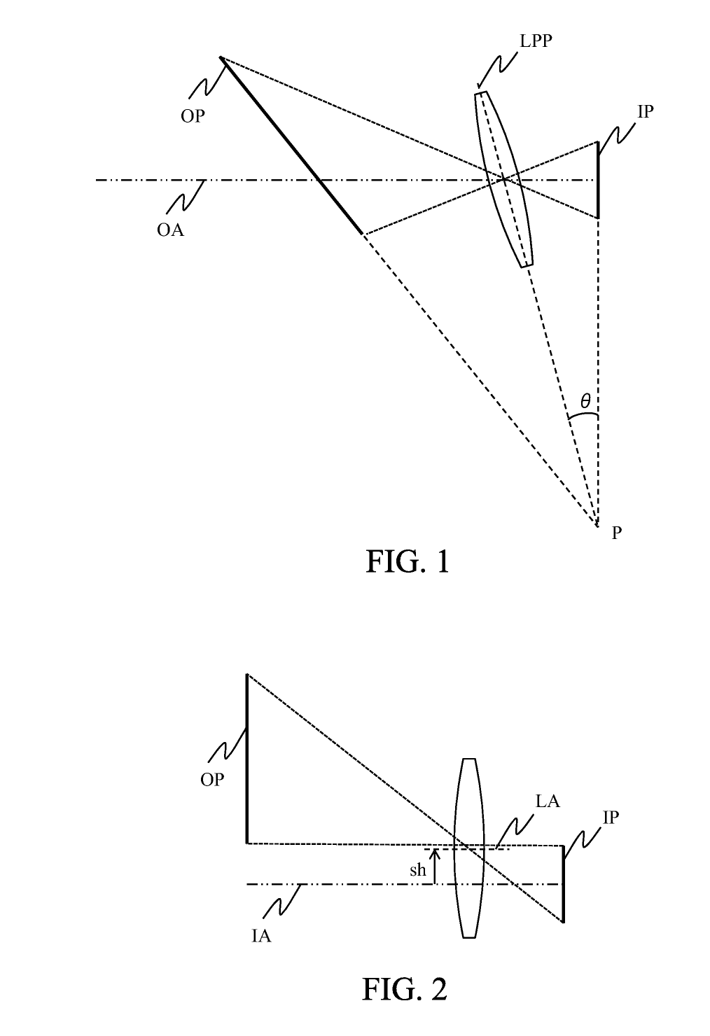

FIG. 1 shows tilt photography according to Scheimpflug principle. The tilt photography is performed by tilting an image capturing optical system, in other words, by tilting a principal plane LPP of the image capturing optical system, with respect to an image pickup plane IP. An object plane OP on which the image capturing optical system is focused, the principal plane LP of the image capturing optical system and the image pickup plane IP intersect with one another at one straight line (shown as one point in FIG. 1) P. In the tilt photography, since the object plane OP on which the image capturing optical system is focused is tilted with respect to the image pickup plane IP, a distance range on which the image capturing optical system is focused can be controlled irrespective of an F-number thereof. For example, the image capturing optical system can focus on the whole of a deep object plane OP without increasing the F-number to increase depth of field. On the other hand, extremely narrowing the distance range on which the image capturing optical system is focused enables diorama-like photography and the like.

FIG. 2 shows shift photography. The shift photography is performed by moving (shifting) the image capturing optical system parallel to the image pickup plane IP, that is, in a direction orthogonal to an optical axis LA. In other words, the shift photography is performed by displacing the optical axis LA of the image capturing optical system with respect to a center axis IA of the image pickup plane IP (that is, a straight line passing through a center of the image pickup plane IP and being orthogonal to the image pickup plane IP). In the shift photography, maintaining a parallel relation between the object plane OP and the image pickup plane IP and adjusting an angular relation therebetween enables control of distortion caused by perspective. For example, when capturing an image of a tall structure, a wall narrowing toward its top can be corrected such that the wall extends upward with a constant width. On the other hand, tilt of the wall can be emphasized.

These tilt photography and shift photography can be performed respectively by providing a tilt mechanism and a shift mechanism to the image capturing optical system. In the following description, the tilt photography and the shift photography are also collectively referred to as “tilt-shift photography”. The term “tilt-shift photography” means “tilt or shift photography”. In addition, the image capturing optical system may be provided with a revolving mechanism making a direction of the tilt or the shift changeable.

In the tilt photography, since the object plane OP, the principal plane LP of the image capturing optical system and the image pickup plane IP are not parallel to one another, eccentric aberration is generated. Also in the shift photography, since the optical axis LA of the image capturing optical system does not coincide with the canter axis IA of the image pickup plane IP, eccentric aberration is generated. The eccentric aberration includes eccentric coma aberration, eccentric distortion aberration, chromatic shift caused by eccentricity, and the like. Such eccentric aberration due to the tilt-shift photography is generated as non-rotationally symmetric aberration about the center of the image pickup plane IP.

As an image process to correct image degradation caused by aberration of an image capturing optical system, an image restoration process is known which uses information on optical transfer function (OTF) of the image capturing optical system. On the other hand, as an image process to correct geometric distortion such as chromatic aberration of magnification and distortion aberration (hereinafter simply called “distortion”), a geometric transform process.

Next, description will be made of definition of terms to be used in the embodiments and an image restoration process performed in the embodiments.

### “Input Image”

The input image is a digital image produced by image capturing performed by an image pickup apparatus, that is, by using output from an image sensor photoelectrically converting an object image formed by an image capturing optical system. The image sensor is constituted by a photoelectric conversion element such as a CCD sensor or a CMOS sensor. The digital image is degraded in response to an optical transfer function (OTF) of the image capturing optical system constituted by lenses and various optical filters. The optical transfer function includes information on aberration of the image capturing optical system. The image capturing optical system may be constituted by reflective surfaces such as mirrors each having curvature. Moreover, the image capturing optical system may be detachably attachable (interchangeable) to the image pickup apparatus. In the image pickup apparatus, the image sensor and a signal processor that produces the digital image (input image) by using the output from the image sensor constitute an image capturing system.

A degradation component of the input image is a blur component caused by various aberrations of the image capturing optical system such as spherical aberration, coma aberration, field curvature and astigmatism. Such a blur component (degradation component) is generated because a light flux emitted from one point of an object forms an optical image with some divergence on an image pickup plane, the light flux being normally converged at one point if there is no aberration or diffraction. The blur component herein is optically expressed as a point spread function (PSF), which is different from blur caused by defocusing.

Moreover, color blur in a color image caused due to longitudinal chromatic aberration, chromatic spherical aberration or chromatic coma aberration of the optical system can be said to be a difference between blurring degrees of respective light wavelengths. In addition, horizontal color shift caused by chromatic aberration of magnification of the optical system can be said to be position shift or phase shift of color light components caused by differences of image capturing magnifications for the respective color light components.

Moreover, the chromatic aberration of magnification is generated in an image pickup apparatus that captures, according to its spectral characteristics, color components such as R, G and B whose imaging positions are mutually shifted due to differences of imaging magnifications of its optical system for respective light wavelengths. Therefore, not only the shift of the imaging positions among the color components is generated, but also shift of imaging positions among wavelengths in each color component, that is, image spread due to the phase shift is generated. Thus, although, strictly speaking, the chromatic aberration of magnification is not merely a chromatic shift that is parallel shift of colors, this specification treats the chromatic shift as the chromatic aberration of magnification. The distortion aberration does not degrade sharpness of an image, but causes distortion of the image and thereby results in image degradation in a broad meaning.

The input image has information on color components such as R, G and B components. The color components can be also expressed by, other than the RGB, an optionally selected one of general color spaces such as LCH (lightness, chroma and hue), YCbCr (luminance, blue color difference and red color difference), XYZ, Lab, Yuv and JCh, or can be expressed by color temperature.

The input image and a restored image (output image) can be provided with information on an image capturing condition in the image pickup apparatus at a time of producing the input image, the image capturing condition including a focal length and an aperture value of the image capturing optical system, an image capturing distance (object distance) and the like. The information on the image capturing condition is hereinafter referred to as “image capturing condition information”. In addition, the input image can be provided with correction information to be used for correction of the input image such as information on a condition of the tilt-shift photography, which will be described later and other information. When outputting the input image from the image pickup apparatus to an image processing apparatus separated therefrom and performing the image restoration process in the image processing apparatus, it is desirable to add the image capturing condition information and the correction information to the input image. The image processing apparatus can receive the image capturing condition information and the correction information from the image pickup apparatus not only by addition to the input image, but also through direct or indirect communication and through a storage medium detachably attachable to these apparatuses.

“Image Restoration Process”

The outline of the image restoration process is as follows. When g(x,y) represents an input image (degraded image) produced through image capturing performed by the image pickup apparatus, f(x,y) represents a non-degraded original image, h(x,y) represents a point spread function (PSF) that forms a Fourier pair with the optical transfer function (OTF), * represents convolution, and (x,y) represents coordinates in the input image, the following expression is established:

g(x,y)=h(x,y)*f(x,y).

Converting the above expression into a form of a two-dimensional frequency surface through Fourier transform provides the following expression of a form of a product for each frequency:

G(u,v)=H(u,v)·F(u,v)

where H represents a result of the Fourier transform of the point spread function (PSF), in other words, the optical transfer function (OTF), G and F respectively represent results of the Fourier transform of g and h, and (u,v) represents coordinates on the two-dimensional frequency surface, in other words, a frequency.

Dividing both sides of the above expression by H as below provides the original image from the degraded image produced through the image capturing:

G(u,v)/H(u,v)=F(u,v)

Returning F(u,v), that is, G(u,v)/H(u,v) to a real surface by inverse Fourier transform provides a restored image equivalent to the original image f(x, Y).

When R represents a result of the inverse Fourier transform of H⁻¹, performing a convolution process for an image in the real surface as represented by the following expression also enables provision of the original image:

g(x,y)*R(x,y)=f(x,y).

This R(x,y) in the above expression is an image restoration filter. When the input image is a two-dimensional image, the image restoration filter is generally also a two-dimensional filter having taps (cells) each corresponding to each of pixels of the two-dimensional image. Moreover, increase of the number of the taps (cells) in the image restoration filter generally improves image restoration accuracy, so that a realizable number of the taps is set depending on requested image quality, image processing capability, aberration characteristics of the image capturing optical system and others.

Since the image restoration filter needs to reflect at least the aberration characteristics, the image restoration filter is different from a conventional edge enhancement filter (high-pass filter) or the like having about three taps in each of horizontal and vertical directions. The image restoration filter is produced based on the optical transfer function (OTF), which can highly accurately correct degradation of amplitude and phase components of the degraded image (input image).

Moreover, since an actual input image (degraded image) includes a noise component, use of an image restoration filter produced from the complete inverse number of the optical transfer function (OTF) as described above not only restores the degraded image, but also significantly amplifies the noise component. This is because such an image restoration filter raises a modulation transfer function (MTF), that is, an amplitude component of the image capturing optical system to 1 over an entire frequency range in a state where amplitude of the noise component is added to the amplitude component of the input image. Although the MTF corresponding to amplitude degradation by the image capturing optical system is returned to 1, power spectrum of the noise component is simultaneously raised, which results in amplification of the noise component according to a degree of raising of the MTF, that is, a restoration gain.

Therefore, the noise component included in the input image makes it impossible to provide a good restored image as an image for appreciation. Such raising of the noise component is shown by the following expressions where N represents the noise component:

G(u,v)=H(u,v)−F(u,v)+N(u,v)

G(u,v)/H(u,v)=F(u,v)+N(u,v)/H(u,v)

As a method for solving such a problem, there is known, for example, a Wiener filter expressed by the following expression (1), which controls image restoration degree according to an intensity ratio (SNR) of an image signal and a noise signal.

$$M ( u , v ) = 4 \frac{1}{H ( u , v )} \frac{{\vert H ( u , v ) \vert}^{2}}{{\vert H ( u , v ) \vert}^{2} + {SNR}^{2}}$$

In the above expression (1), M(u,v) represents a frequency characteristic of the Wiener filter, and |H(u,v)| represents an absolute value (MTF) of the optical transfer function (OTF). This method decreases, at each frequency, the restoration gain as the MTF is lower, in other words, increases the restoration gain as the MTF is higher. The MTF of general image capturing optical systems is high on a low frequency side and low on a high frequency side, so that the method resultantly suppresses the restoration gain on the high frequency side of the image signal.

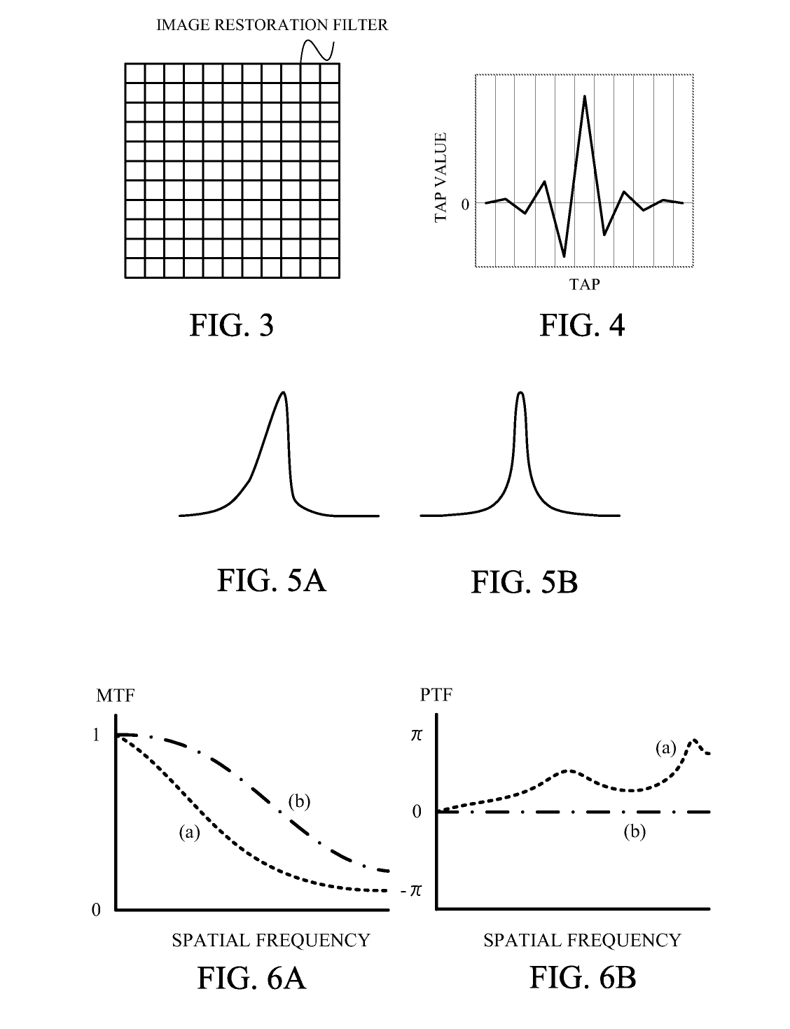

An example of the image restoration filter is shown in FIGS. 3 and 4. For the image restoration filter, the number of the taps (cells) is decided corresponding to aberration characteristics of the image capturing optical system and required image restoration accuracy.

The image restoration filter shown in FIG. 3 is a two-dimensional filter having 11×11 taps. Although FIG. 3 omits values in the respective taps, FIG. 4 shows one section of this image restoration filter where values of the taps (in other words, filter values or filter coefficients, and hereinafter also referred to as “tap values”) is shown by a polygonal line. A distribution of the tap values in the image restoration filter plays a role to return signal values (PSF) spatially spread due to the aberration to, ideally, one point.

The image restoration process performs convolution of each tap value of the image restoration filter on each pixel (corresponding to each tap) of the input image. In the convolution, in order to improve the signal value of a certain pixel in the input image, that pixel is matched to a center tap of the image restoration filter. Then, a product of the pixel signal value of the input image and the tap value of the image restoration filter is calculated for each corresponding pair of the pixel in the input image and the tap of the image restoration filter, and the signal value of the pixel corresponding to the center tap of the filter is replaced by a total sum of the products.

Characteristics of the image restoration in a real space and a frequency space will be described with reference to FIGS. 5A, 5B, 6A and 6B. FIG. 5A shows a PSF (point spread function) before the image restoration, and FIG. 5B shows a PSF after the image restoration. FIG. 6A shows (a) an MTF before the image restoration and (b) an MTF after the image restoration. FIG. 6B shows (a) a PTF (phase transfer function) before the image restoration and (b) a PTF after the image restoration. The PSF before the image restoration asymmetrically spreads, and the PTF changes non-linearly with frequency due to the asymmetry. The image restoration process amplifies the MTF and corrects the PTF to zero, so that the PSF after the image restoration becomes symmetric and sharp.

This image restoration filter can be obtained by inverse Fourier transform of a function designed on the basis of an inverse function of the optical transfer function (OTF) of the image capturing optical system. The image restoration filter used in the embodiments can be arbitrarily changed, and for example, the Wiener filter may be used as the image restoration filter. In the case of using the Wiener filter, the image restoration filter for the convolution on the input image in the real space can be produced by the inverse Fourier transform of the expression (1).

Moreover, since the optical transfer function (OTF) changes depending on image heights (positions in the input image) even under a same image capturing condition, the image restoration filter to be used is changed depending on the image heights.

Next, specific embodiments of the present invention will be described.

### Embodiment 1

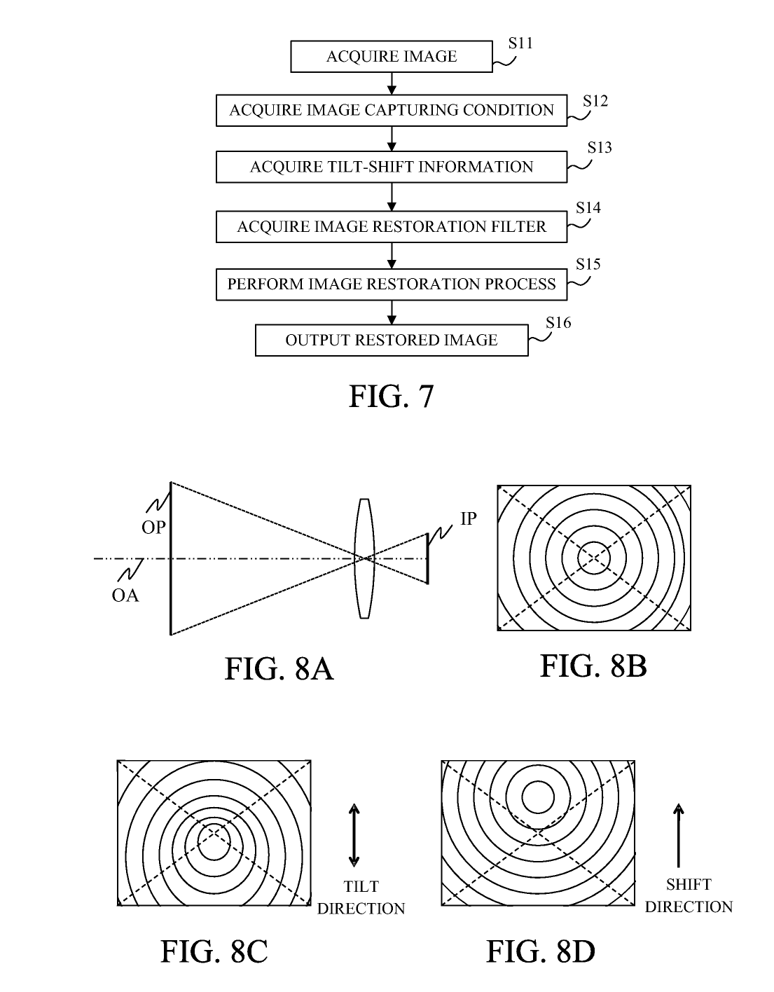

FIG. 7 shows a procedure of an image processing method that is a first embodiment (Embodiment 1) of the present invention. In this embodiment, description is made of a case of performing, as an image process to correct image degradation caused by aberration of an image capturing optical system in the tilt-shift photography, the above-described image restoration process.

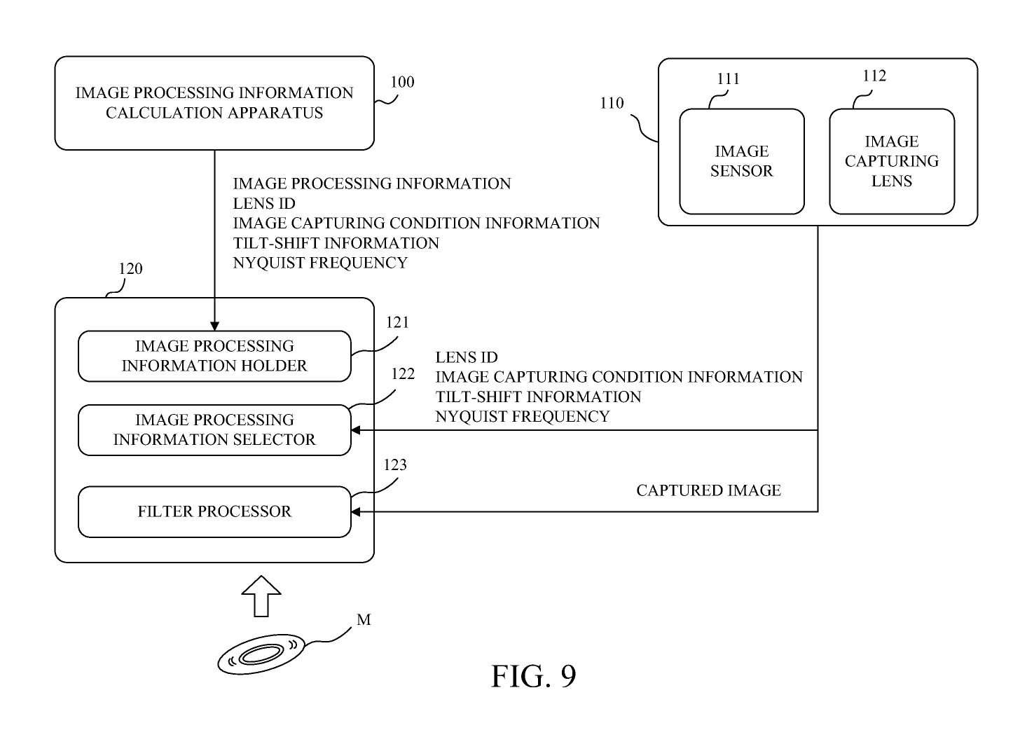

The image processing method of this embodiment is performed by a computer as an image processing apparatus constituted by a CPU and others according to an image processing program as a computer program. The image processing program can be installed through a network or a recording medium (non-transitory computer-readable storage medium) such as a semiconductor memory or an optical disc. This also applies to other embodiments described later (reference character M in FIG. 9 denotes the recording medium).

Moreover, in this embodiment, description will be made of a case where an image processing apparatus separate from an image pickup apparatus capable of performing the tilt-shift photography performs the image process. However, the image processing apparatus may be provided in the image pickup apparatus. In this case, the image pickup apparatus corresponds to an image capturer, and the image processing apparatus corresponds to an image processor.

First, at step S11, the computer as the image processing apparatus acquires (prepares), as an input image, a captured image produced by the image pickup apparatus performing the tilt-shift photography. The computer may acquire the input image from the image pickup apparatus through wired or wireless communication or via a recording medium such as a semiconductor memory or an optical disc.

Next, at step S12, the computer acquires image capturing condition information showing an image capturing condition when the image pickup apparatus produced the captured image by the tilt-shift photography. The image capturing condition includes, as mentioned above, a focal length of the image capturing optical system, an aperture value thereof, an object distance and identification information (camera ID) of the image pickup apparatus. Moreover, when the image pickup apparatus is a so-called lens interchangeable type (the image capturing optical system is interchangeable), the image capturing condition may include identification information (lens ID) of the image capturing optical system. The image capturing condition information may be acquired by the computer as information added to the captured image as mentioned above or through wired or wireless communication or via a recording medium.

Next, at step S13, the computer acquires information showing a condition (or a state) of the tilt-shift photography when the image pickup apparatus produced the captured image by the tilt-shift photography, that is, information showing a condition of the tilt or shift of the image capturing optical system. When acquiring the information showing the condition of the tilt-shift photography, the computer first determines whether or not the image pickup apparatus performed the tilt-shift photography, that is, whether or not the image capturing optical system was tilted or shifted with respect to an image pickup plane of the image pickup apparatus (image sensor).

If determining that the image pickup apparatus performed the tilt-shift photography, the computer acquires the information on a tilt direction shown by an arrow in FIG. 1 and a tilt angle showing by θ in FIG. 1 with respect to the image pickup plane or the information on a shift direction shown by an arrow in FIG. 2 and a shift amount showing by sh in FIG. 2 with respect to the image pickup plane, which are the information showing the condition of the tilt-shift photography. In the following description, the information showing the condition of the tilt-shift photography is referred to as “tilt-shift information”.

Next, at step S14, the computer acquires an image restoration filter used for an image restoration process. Specifically, the computer selects, from multiple image restoration filters each corresponding to each condition of the tilt-shift photography and each image capturing condition, which are stored in a memory (not shown) beforehand, one image restoration filter corresponding to the tilt-shift information acquired at step S13 and the image capturing condition information acquired at step S12.

The computer may produce the image restoration filter corresponding to the tilt-shift information and the image capturing condition information using a calculation expression for calculating the image restoration filter. For example, the computer may use a calculation expression for producing an image restoration filter characteristic in a frequency space on a basis of the tilt-shift information and an optical transfer function (OTF) of the image capturing optical system corresponding to the image capturing condition and then performing inverse Fourier transform on the image restoration filter characteristic to convert it to a filter in a real space.

Description is here made of the optical transfer function of the image capturing optical system in the tilt-shift photography. FIG. 8A shows an image capturing optical system not for the tilt-shift photography, but for normal photography. In the normal photography, an optical axis OA of the image capturing optical system coincides with a center of an image pickup plane IP (captured image center), and the optical transfer function (contours thereof in the image pickup plane IP are shown in FIG. 8B) is rotationally symmetric about the center of the image pickup plane IP in image height directions, which are radial directions from the center.

On the other hand, in the image capturing optical system for the tilt photography according to Scheimpflug principle shown in FIG. 1, the object plane OP on which the image capturing optical system is focused is not orthogonal to the optical axis OA. The tilt of the image capturing optical system generates the eccentric aberration, and object distances for a plus side image height and a minus side image height are different from each other, so that the optical transfer function (contours thereof in the image pickup plane IP are shown in FIG. 8C) becomes non-rotationally symmetric about the center of the image pickup plane IP. Therefore, when performing the tilt photography, it is necessary to produce an image restoration filter enabling an image restoration process based on the optical transfer function having non-rotational symmetry about the captured image center due to difference of the object distances for the respective image heights.

In order to acquire the optical transfer function for each image height in the image pickup plane, it is necessary to acquire (detect) the tilt direction of the image capturing optical system. The optical transfer function is non-line-symmetric in the tilt direction. However, since symmetry of the image capturing optical system is maintained in a direction orthogonal to the tilt direction, the optical transfer function is also line-symmetric in that direction. Therefore, when acquiring the optical transfer function, performing an interpolation process using the line-symmetry thereof in the direction orthogonal to the tilt direction makes it possible to reduce data amount.

In addition, tilt of the object plane OP is changed depending on the object distance (distance from the object to the image pickup plane IP) and on the tilt direction and tilt angle of the image capturing optical system. Hence, in order to acquire the optical transfer function for each image height in the tilt photography, it is necessary to acquire (detect) the tilt angle, in addition to the tilt direction.

When using the tilt direction and the tilt angle, a data table may be produced which shows the tilt of the object plane OP corresponding to the tilt direction, the tilt angle and the object distance. This data table enables acquisition of the object distance for each image height in any condition of the tilt photography.

Moreover, in the image capturing optical system for the shift photography, as shown in FIG. 2, the optical axis LA of the image capturing optical system is displaced with respect to the center line IA of the image pickup plane IP, so that the optical transfer function (contours thereof in the image pickup plane IP are shown in FIG. 8D) is also displaced with respect to the center of the image pickup plane IP. Therefore, when performing the shift photography, it is necessary to perform an image restoration process based on the optical transfer function having an offset in the shift direction from the center of the captured image, in other words, having non-rotational symmetry about the center of the captured image. In order to acquire an image restoration filter appropriate for such an image restoration process, it is necessary to acquire (detect) the shift direction and shift amount of the image capturing optical system.

In a case where, in the tilt photography, a center of the tilt is not located in an image side principal plane of the image capturing optical system, the image capturing optical system is not only tilted, but also shifted. In this case, using both methods of acquiring the optical transfer functions respectively corresponding to the tilt photography and the shift photography enables selection or production of an appropriate image restoration filter.

Thus, the image restoration filter is acquired by using the information on the aberration of the image capturing optical system (that is, on the optical transfer function) corresponding to the tilt-shift information in the tilt-shift photography.

The computer having acquired the image restoration filter performs at step S15 the image restoration process by performing convolution of the image restoration filter on the captured image to produce a restored image. Steps S14 and S15 correspond to a processing step.

Then, at step S16, the computer outputs the produced restored image to store it to a recording medium and to display it on a monitor.

Although this embodiment described the case of performing the image restoration process as the image process for correcting the image degradation, another correction process for correcting chromatic aberration of magnification or distortion may be performed in place of or together with the image restoration process. Of course, the other process is appropriately performed so as to correspond to the condition of the tilt-shift photography.

### Embodiment 2

FIG. 9 shows an image processing system including an image processing apparatus that is a second embodiment (Embodiment 2) of the present invention. The image processing system is constituted by an image processing information calculation apparatus 100, a camera (image pickup apparatus) 110 and the image processing apparatuses 120.

The image processing information calculation apparatus 100 calculates image processing information including an optical transfer function (OTF), a correction amount for chromatic aberration of magnification (hereinafter referred to as “a chromatic aberration correction amount”) and a correction amount for distortion (hereinafter referred to as “a distortion correction amount”). The image processing information calculation apparatus 100 calculates the image processing information for each of multiple combinations of various types of image capturing optical systems and various types of cameras provided with different types of image sensors and outputs the calculated image processing information to the image processing apparatus 120.

The camera 110 includes an image sensor 111 and an image capturing lens (image capturing optical system) 112. The camera 110 produces a captured image by image capturing through the image capturing lens 112 and outputs the captured image. Moreover, the camera 110 adds a lens ID of the image capturing lens 112 and image capturing condition information (an aperture value, a focal length, an image capturing distance, tilt-shift information and a Nyquist frequency of the image sensor 111) to the captured image and outputs it.

The image processing apparatus 120 holds the image processing information output from the image processing information calculation apparatus 100 and the captured image with the lens ID and the image capturing condition information output from the camera 110 and performs, by using these information, processes for correcting the captured image degraded by the image capturing lens 112 such as an image restoration process, a correction process for correcting the chromatic aberration of magnification (hereinafter referred to as “a chromatic aberration correction process) and a correction process for correcting the distortion (hereinafter referred to as “a distortion correction process).

The image processing apparatus 120 includes an image processing information holder 121, an image processing information selector 122 and a filter processor 123. The image processing information holder 121 holds (stores) the image processing information, the lens ID, the image capturing condition information, the tilt-shift information and information of the Nyquist frequency of the image sensor 111 for each of the multiple combinations of the image capturing optical systems and the cameras for which the image processing information has been calculated by the image processing information calculation apparatus 100. The image processing information holder 121 corresponds to a tilt-shift information acquirer.

The image processing information selector 122 acquires the information on the Nyquist frequency of the image sensor 111, the lens ID and the image capturing condition information from the camera 110. Moreover, the image processing information selector 122 searches for, among the image processing information stored in the image processing information holder 121, specific image processing information corresponding to the lens ID of the image capturing lens 112, the image capturing condition information and the Nyquist frequency of the image sensor 111. The image processing information selector 122 selects, by using the searched information, in a spatial frequency range up to the Nyquist frequency of the image sensor 111, the image processing information to be used by the filter processor 123. The image processing information selected by the image processing information selector 122 is hereinafter referred to as “selected image processing information”.

The filter processor 123 acquires the captured image from the camera 110. The filter processor 123 further produces, by using the selected image processing information, at least one of an image restoration filter and a geometric transform filter and performs at least one of the image restoration process, the chromatic aberration correction process and the distortion correction process to correct the degradation of the captured image. The filter processor 123 corresponds to an image acquirer and a processor.

Holding (storing) the image processing information calculated beforehand by the image processing information calculation apparatus 100 in the image processing information holder 121 eliminates a necessity of providing the image processing information calculation apparatus 100 to a user. The user can download and use information necessary for the image processing through a network and a recording medium.

Next, description will be made of a method of calculating the image processing information in the image processing information calculation apparatus 100. The optical transfer function (OTF), the chromatic aberration correction amount and the distortion correction amount which are calculated by the image processing information calculation apparatus 100 are calculated by using information on aberration of the image capturing optical system (image capturing lens 112) corresponding to tilt-shift information.

For example, in a case of performing the tilt photography (that is, a case where the image capturing optical system includes a tilt mechanism), it is necessary to reflect a tilt angle detected by an angle detector such as an encoder in the calculation. In this case, the tilt angle may be detected as a relative angle of the image capturing optical system with respect to the image pickup plane. On the other hand, in a case of performing the shift photography (that is, a case where the image capturing optical system includes a shift mechanism), it is necessary to detect a shift amount by a movement amount detector constituted by a scale and a photo sensor or the like outputting a signal corresponding to a relative movement amount of the scale and the photo sensor. In this case, the shift amount may be detected as a relative parallel movement amount of the image capturing optical system with respect to the image pickup plane. Moreover, detecting a tilt direction and a shift direction enables decision of a direction in which the image processing is performed on the captured image.

When performing the tilt photography, since the object plane OP and the image pickup plane IP are not parallel to each other according to Scheimpflug principle shown in FIG. 1, object distances for respective image heights are different from one another. In such tilt photography, it is desirable to calculate beforehand tilt of the object plane OP from the tilt angle of the image capturing optical system and the object distance and to hold object distance data for each image height as part of the image processing information. This enables calculation of appropriate image processing information for the tilt photography, which results in that the image process is performed with non-rotationally symmetry about the center of the image pickup plane.

Moreover, in the shift photography, the optical axis LA of the image capturing optical system does not coincide with the center axis IA of the image pickup plane IP as shown in FIG. 2, and image degradation caused by the aberration of the image capturing optical system has an offset corresponding to the shift amount of the image capturing optical system. In such shift photography, providing to the image processing information an offset in the shift direction with respect to the center of the image pickup plane corresponding to the shift amount of the image capturing optical system enables calculation of appropriate image processing information, which results in that the image process is performed with the offset with respect to the center of the image pickup plane.

As described above, the optical transfer function has the non-rotational symmetry about the center of the image pickup plane in the tilt-shift photography. Thus, the image restoration filter produced on a basis of the optical transfer function also has non-rotational symmetry. Therefore, the image restoration process can be said to be performed on the basis of the optical transfer function having non-rotational symmetry. The image restoration process may be performed by using image restoration filters different for respective color components such as R, G and B.

Furthermore, since the chromatic aberration of magnification and the distortion have a non-rotationally symmetric component (including also an offset component) about the center of the image pickup plane in the tilt-shift photography, it is necessary to decide the chromatic aberration correction amount and the distortion correction amount in consideration of displacement amounts of imaging positions calculated on a basis of the non-rotationally symmetric component. The chromatic aberration correction amount may be decided for each of the color component such as R, G and B. The distortion correction amount may be decided for each of the image heights.

### Embodiment 3

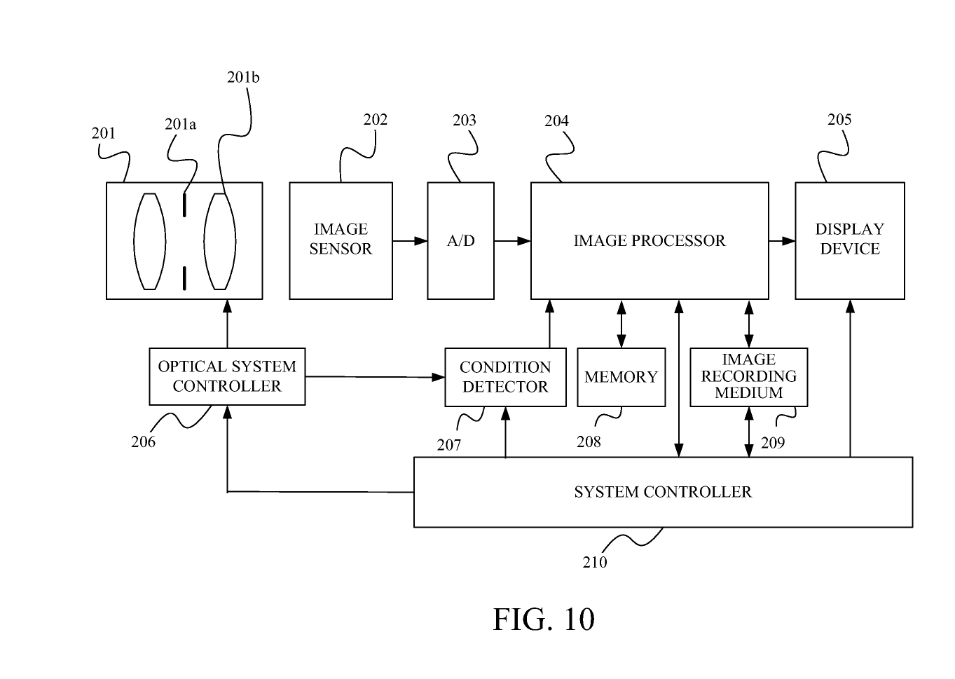

FIG. 10 shows a configuration of an image pickup apparatus that is a third embodiment (Embodiment 3) of the present invention. This image pickup apparatus is provided with (includes thereinside) an image processor 204 as an image processing apparatus.

An image capturing optical system 201 including an aperture stop 201a and lenses 201b such as a zoom lens and a focus lens causes light from an object (not shown) to form an object image on an image pickup plane of an image sensor 202. The image capturing optical system 201 is provided with, though not shown, at least one of a tilt mechanism and a shift mechanism.

The image sensor 202 photoelectrically converts the object image. An A/D converter 203 converts an analog image pickup signal output from the image sensor 202 into a digital image pickup signal. The digital image pickup signal is input to the image processor 204.

The image processor 204 performs predetermined signal processes on the digital image pickup signal to produce a captured image. Moreover, the image processor 204 performs an image restoration process on the captured image (input image). Specifically, the image processor 204 acquires image capturing condition information and tilt-shift information from a condition detector 207. The tilt-shift information may be acquired by using the angle detector and the movement amount detector as described in Embodiment 2 or may be input by a user through a back monitor serving also as an input operation part of the image pickup apparatus. The image sensor 202, the A/D converter 203 and the image processor 204 constitute an image capturer that produces a captured image. The image processor 204 corresponds to an image acquirer, a tilt-shift information acquirer and a processor.

The condition detector 207 may receive the image capturing condition information from a system controller 210, and may receive part of the image capturing condition information relating to the image capturing optical system from an optical system controller 206 that controls operations of the aperture stop 201a and movement of the lenses 201b. The image processor 204 performs the processes described by using the flowchart shown in FIG. 7. Data of optical transfer function (OTF) and others are held (stored) in a memory 208 in advance.

The image processor 204 outputs a restored image that is an output image produced by the image restoration process and causes an image recording medium 209 and a display device 205 to store and display the restored image. The above-described series of operations is controlled by the system controller 210.

The image-capturing optical system 201 may include an optical element such as a low-pass filter or an infrared-cutting filter. However, in a case of using the optical filter such as the low-pass filter that influences a characteristic of an optical transfer function (OTF) of the image capturing optical system 201, the influence of the optical filter is needed to be considered in production of the image restoration filter. When using the infrared cutting filter, since it provides an influence to a PSF (which is an integration value of a point spread function (PSF) of a spectral wavelength) for each of R, G and B channels, particularly on the PSF for the R channel, the infrared-cutting filter should be taken into account when producing the image restoration filter.

The image capturing optical system 201 may be interchangeable to the image pickup apparatus, as mentioned above.

In addition, in this embodiment, the chromatic aberration correction process or the distortion correction process described in Embodiment 2 may be performed in place of or together with the image restoration process.

Each of the above-described embodiments enables good correction of the image degradation due to the tilt-shift photography, which enables provision of a high quality image.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-167763, filed on Jul. 27, 2012, which is hereby incorporated by reference herein in its entirety.

What is claimed is:

1. An image processing method comprising:
acquiring an input image produced by image capturing through an image capturing optical system tilted with respect to an image pickup plane;
acquiring tilt information showing a condition of the tilt of the image capturing optical system in the image capturing; and
performing an image process on the input image, by using information on aberration of the image capturing optical system corresponding to the tilt information, to correct image degradation caused by the aberration,
wherein the tilt information shows a tilt direction and a tilt angle of the image capturing optical system with respect to the image pickup plane, and
wherein the method acquires object distances for respective image heights in the image pickup plane by using the tilt direction and the tilt angle and performs the image process corresponding to the object distance for each image height.

2. An image processing method according to claim 1, wherein the method performs, as the image process, an image restoration process based on an optical transfer function of the image capturing optical system tilted with respect to the image pickup plane, the optical transfer function being non-rotationally symmetric about a center of the image pickup plane.

3. An image processing method according to claim 2, wherein the method acquires the optical transfer function of the image capturing optical system by an interpolation process based on line symmetry of the optical transfer function in a direction orthogonal to the tilt direction.

4. An image processing method according to claim 1, wherein the method performs, as the image process, a correction process based on at least one of chromatic aberration of magnification and distortion aberration of the image capturing optical system tilted with respect to the image pickup plane, each aberration being non-rotationally symmetric aberration about a center of the image pickup plane.

5. An image processing apparatus comprising:
an image acquirer configured to acquire an input image produced by image capturing through an image capturing optical system tilted with respect to an image pickup plane;
a tilt information acquirer configured to acquire tilt information showing a condition of the tilt of the image capturing optical system in the image capturing; and
a processor configured to perform an image process on the input image, by using information on aberration of the image capturing optical system corresponding to the tilt information, to correct image degradation caused by the aberration,
wherein the tilt information shows a tilt direction and a tilt angle of the image capturing optical system with respect to the image pickup plane, and
wherein the processor is configured to acquire object distances for respective image heights in the image pickup plane by using the tilt direction and the tilt angle and to perform the image process corresponding to the object distance for each image height.

6. An image pickup apparatus comprising:
an image capturer configured to perform image capturing through an image capturing optical system tilted with respect to an image pickup plane to produce a captured image; and
an image processing apparatus comprising:
an image acquirer configured to acquire the captured image as an input image;
a tilt information acquirer configured to acquire tilt information showing a condition of the tilt of the image capturing optical system in the image capturing; and
a processor configured to perform an image process on the input image, by using information on aberration of the image capturing optical system corresponding to the tilt information, to correct image degradation caused by the aberration,
wherein the tilt information shows a tilt direction and a tilt angle of the image capturing optical system with respect to the image pickup plane, and
wherein the processor is configured to acquire object distances for respective image heights in the image pickup plane by using the tilt direction and the tilt angle and to perform the image process corresponding to the object distance for each image height.

7. A non-transitory computer-readable storage medium storing an image processing program that causes a computer to perform an operation comprising:
acquiring an input image produced by image capturing through an image capturing optical system tilted with respect to an image pickup plane;
acquiring tilt information showing a condition of the tilt of the image capturing optical system in the image capturing; and
performing an image process on the input image, by using information on aberration of the image capturing optical system corresponding to the tilt information, to correct image degradation caused by the aberration,
wherein the tilt information shows a tilt direction and a tilt angle of the image capturing optical system with respect to the image pickup plane, and
wherein the method acquires object distances for respective image heights in the image pickup plane by using the tilt direction and the tilt angle and performs the image process corresponding to the object distance for each image height.

8. An image processing method comprising:
acquiring an input image produced by image capturing through an image capturing optical system shifted with respect to an image pickup plane;
acquiring shift information showing a condition of the shift of the image capturing optical system in the image capturing; and
performing an image process on the input image, by using information on aberration of the image capturing optical system corresponding to the shift information, to correct image degradation caused by the aberration.

9. An image processing method according to claim 8, wherein the shift information shows a shift direction and a shift amount of the image capturing optical system with respect to the image pickup plane.

10. An image processing method according to claim 9, wherein the method performs, as the image process, an image process with an offset corresponding to the shift direction and the shift amount from a center of the input image.

11. An image processing method according to claim 8, wherein the method performs, as the image process, an image restoration process based on an optical transfer function of the image capturing optical system shifted with respect to the image pickup plane, the optical transfer function being non-rotationally symmetric about a center of the image pickup plane.

12. An image processing method according to claim 8, wherein the method performs, as the image process, a correction process based on at least one of chromatic aberration of magnification and distortion aberration of the image capturing optical system shifted with respect to the image pickup plane, each aberration being non-rotationally symmetric aberration about a center of the image pickup plane.

13. An image processing apparatus comprising:
an image acquirer configured to acquire an input image produced by image capturing through an image capturing optical system shifted with respect to an image pickup plane;
a shift information acquirer configured to acquire shift information showing a condition of the shift of the image capturing optical system in the image capturing; and
a processor configured to perform an image process on the input image, by using information on aberration of the image capturing optical system corresponding to the shift information, to correct image degradation caused by the aberration.

14. An image pickup apparatus comprising:
an image capturer configured to perform image capturing through an image capturing optical system shifted with respect to an image pickup plane to produce a captured image; and
an image processing apparatus comprising:
an image acquirer configured to acquire the captured image as an input image;
a shift information acquirer configured to acquire shift information showing a condition of the shift of the image capturing optical system in the image capturing; and
a processor configured to perform an image process on the input image, by using information on aberration of the image capturing optical system corresponding to the shift information, to correct image degradation caused by the aberration.

15. A non-transitory computer-readable storage medium storing an image processing program that causes a computer to perform an operation comprising:
acquiring an input image produced by image capturing through an image capturing optical system shifted with respect to an image pickup plane;
acquiring shift information showing a condition of the shift of the image capturing optical system in the image capturing; and
performing an image process on the input image, by using information on aberration of the image capturing optical system corresponding to the shift information, to correct image degradation caused by the aberration.
